(19) United States
(12) Patent Application Publication
(10) Pub. No.: US 2024/0428396 A1
(43) Pub. Date: Dec. 26, 2024

(54) MACHINE LEARNING BASED DEFECT EXAMINATION FOR SEMICONDUCTOR SPECIMENS

(71) Applicant: Applied Materials Israel Ltd., Rehovot (IL)

(72) Inventors: Boris SHERMAN, Rehovot (IL); Boris LEVANT, Rehovot (IL); Ran YACOBY, Jerusalem (IL); Bar DUBOVSKI, Beit Hashmonay (IL); Botser RESHEF, Shoham (IL); Tomer YEMINY, Givat Shmuel (IL); Omer GRANOVITER, Tel-Aviv (IL); Ran BADANES, Rishon Le-Zion (IL)

(21) Appl. No.: 18/212,179

(22) Filed: Jun. 20, 2023

(51) Int. Cl. G06T 7/00; G06T 7/10; G06V 10/44; G06V 10/70; G06V 20/70

(52) U.S. Cl. CPC G06T 7/0008; G06T 7/10; G06V 10/44; G06V 10/70; G06V 20/70; G06T 2207/20081; G06T 2207/30148

(57) ABSTRACT

There is provided a system and method of semiconductor specimen examination. The method includes obtaining a plurality of images of a semiconductor specimen acquired by an examination tool; processing the plurality of images using a first machine learning (ML) model for defect detection, thereby obtaining, from the plurality of images, a set of images labeled with detected defects, wherein the first ML model is previously trained using a first training set comprising a subset of synthetic defective images each containing one or more synthetic defects, and a subset of nominal images; and training a second ML model using a second training set comprising at least part of the set of images labeled with detected defects, wherein the second ML model, upon being trained, is usable for defect detection with improved detection performance with respect to the first ML model.

### TECHNICAL FIELD

The presently disclosed subject matter relates, in general, to the field of examination of a semiconductor specimen, and more specifically, to machine learning based defect examination.

### BACKGROUND

Current demands for high density and performance, associated with ultra large-scale integration of fabricated devices, require submicron features, increased transistor and circuit speeds, and improved reliability. As semiconductor processes progress, pattern dimensions, such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Run-time examination can generally employ a two-phase procedure, e.g., inspection of a specimen followed by review of sampled locations of potential defects. Examination generally involves generating certain output (e.g., images, signals, etc.) for a specimen by directing light or electrons to the wafer, and detecting the light or electrons from the wafer. During the first phase, the surface of a specimen is inspected at high-speed and relatively low-resolution. Defect detection is typically performed by applying a defect detection algorithm to the inspection output. A defect map is produced to show suspected locations on the specimen having high probability of being a defect. During the second phase, at least some of the suspected locations are more thoroughly analyzed with relatively high resolution, for determining different parameters of the defects, such as classes, thickness, roughness, size, and so on.

Examination can be provided by using non-destructive examination tools during or after manufacture of the specimen to be examined. A variety of non-destructive examination tools includes, by way of non-limiting example, scanning electron microscopes, atomic force microscopes, optical inspection tools, etc.

Examination processes can include a plurality of examination steps. The manufacturing process of a semiconductor device can include various procedures, such as etching, depositing, planarization, growth such as epitaxial growth, implantation, etc. The examination steps can be performed a multiplicity of times, for example after certain process procedures, and/or after the manufacturing of certain layers, or the like. Additionally or alternatively, each examination step can be repeated multiple times, for example for different wafer locations, or for the same wafer locations with different examination settings.

Examination processes are used at various steps during semiconductor fabrication for the purpose of process control, such as, e.g., defect related operations, as well as metrology related operations. Effectiveness of examination can be improved by automatization of process(es) such as, for example, defect detection, Automatic Defect Classification (ADC), Automatic Defect Review (ADR), image segmentation, automated metrology-related operations, etc.

Automated examination systems ensure that the parts manufactured meet the quality standards expected, and provide useful information on adjustments that may be needed to the manufacturing tools, equipment and/or compositions, depending on the type of defects identified. In some cases, machine learning technologies can be used to assist the automated examination process so as to promote higher performance.

### SUMMARY

In accordance with certain aspects of the presently disclosed subject matter, there is provided a computerized system of semiconductor specimen examination, the system comprising a processing circuitry configured to: obtain a plurality of images of a semiconductor specimen acquired by an examination tool; process the plurality of images using a first machine learning (ML) model for defect detection, thereby obtaining, from the plurality of images, a set of images labeled with detected defects, wherein the first ML model is previously trained using a first training set comprising: a subset of synthetic defective images each containing one or more synthetic defects, and a subset of nominal images; and train a second ML model using a second training set comprising at least part of the set of images labeled with detected defects and at least part of the subset of nominal images, wherein the second ML model, upon being trained, is usable for defect detection with improved detection performance with respect to the first ML model.

In addition to the above features, the system according to this aspect of the presently disclosed subject matter can comprise one or more of features (i) to (xi) listed below, in any desired combination or permutation which is technically possible:
(i). The second ML model can be based on the first ML model.
(ii) The second ML model can be a new ML model different from the first ML model.
(iii). The processing can comprise, for each given image of the plurality of images, providing a segmentation map comprising values representative of labels indicative of defect-related segments corresponding to the given image, and selecting, from the plurality of images, a set of images each associated with a segmentation map comprising one or more labels representative of defect presence.
(iv). The processing can further comprise, for each given image, providing an additional output representative of image-level indication of defect presence based on features extracted from the given image. In such cases, the selecting can comprise selecting the set of images labeled with detected defects based on consistency between the segmentation map and the additional output.
(v). The processing can further comprise, for each given image, providing an uncertainty map comprising values representative of respective likelihood of the defect-related segments indicated by the segmentation map. In such cases, the selecting can comprise selecting the set of images labeled with detected defects based on the segmentation map and the uncertainty map.
(vi). The subset of synthetic defective images can be generated by implanting one or more defects in design data of the specimen, and simulating the synthetic defective images based on the design data with implanted defects.
(vii). The simulation can be performed by simulating physical effects of one or more processes, including a fabrication process for fabricating a specimen based on the design data, a scanning process for scanning the fabricated specimen, and a signal processing process for processing scanned signals to generate the synthetic defective images.
(viii). The simulation can be performed using an image translation model trained for translating design data of a specimen to a synthetic image.
(ix). The design data can be generated based on an actual image of the specimen.
(x). The first training set can further comprise a subset of real defective images.
(xi). The improved detection performance can be represented by at least one of following detection measures: precision, recall, filter rate, and false alarm rate.

In accordance with other aspects of the presently disclosed subject matter, there is provided a method of semiconductor specimen examination, the method comprising: obtaining a plurality of images of a semiconductor specimen acquired by an examination tool; processing the plurality of images using a first machine learning (ML) model for defect detection, thereby obtaining, from the plurality of images, a set of images labeled with detected defects, wherein the first ML model is previously trained using a first training set comprising: a subset of synthetic defective images each containing one or more synthetic defects, and a subset of nominal images; and training a second ML model using a second training set comprising at least part of the set of images labeled with detected defects, wherein the second ML model, upon being trained, is usable for defect detection with improved detection performance with respect to the first ML model.

These aspects of the disclosed subject matter can comprise one or more of features (i) to (xi) listed above with respect to the system, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of semiconductor specimen examination, the method comprising: obtaining a plurality of images of a semiconductor specimen acquired by an examination tool; processing the plurality of images using a first machine learning (ML) model for defect detection, thereby obtaining, from the plurality of images, a set of images labeled with detected defects, wherein the first ML model is previously trained using a first training set comprising: a subset of synthetic defective images each containing one or more synthetic defects, and a subset of nominal images; and training a second ML model using a second training set comprising at least part of the set of images labeled with detected defects, wherein the second ML model, upon being trained, is usable for defect detection with improved detection performance with respect to the first ML model.

These aspects of the disclosed subject matter can comprise one or more of features (i) to (xi) listed above with respect to the system, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a generalized flowchart of defect examination in accordance with certain embodiments of the presently disclosed subject matter.

FIG. 3 illustrates a generalized flowchart of selecting a set of images with detected defects in accordance with certain embodiments of the presently disclosed subject matter.

FIG. 4 illustrates a generalized flowchart of generating the subset of synthetic defective images in accordance with certain embodiments of the presently disclosed subject matter.

FIG. 5 illustrates a training process for the first ML model in accordance with certain embodiments of the presently disclosed subject matter.

FIG. 6 illustrates a schematic illustration of an exemplary first ML model providing multiple outputs in accordance with certain embodiments of the presently disclosed subject matter.

FIG. 7 illustrates a schematic illustration of the employment of the first ML model and the second ML model in the defect examination system in accordance with certain embodiments of the presently disclosed subject matter.

### DETAILED DESCRIPTION OF EMBODIMENTS

In the following detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the following discussions, it is appreciated that throughout the specification discussions utilizing terms such as “examining”, “obtaining”, “processing”, “extracting”, “comparing”, “generating”, “training”, “acquiring”, “subsampling”, “storing”, “searching”, “computing”, “dividing”, “reviewing”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities, such as, e.g., a personal computer, a server, a computing system, a communication device, and any other electronic computing device, including, by way of non-limiting example, the examination system, the defect examination system, the training system, and respective parts thereof disclosed in the present application.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates including wafers, masks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination” or its derivatives used in this specification are not limited with respect to resolution or size of an inspection area. A variety of non-destructive examination tools includes, by way of non-limiting example, scanning electron microscopes (SEM), atomic force microscopes (AFM), optical inspection tools, etc.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limiting to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results such as measured images are analyzed, for example, by employing image-processing techniques. Note that, unless specifically stated otherwise, the term “metrology” or derivatives thereof used in this specification are not limited with respect to measurement technology, measurement resolution, or size of inspection area.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as a “false alarm” defect) which can be disregarded because it has no effect on the functionality of the completed device and does not impact yield.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats as, by way of non-limiting examples, GDSII format, OASIS format, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data). Depending on the specific way of scanning (e.g., one-dimensional scan such as line scanning, two-dimensional scan in both x and y directions, or dot scanning at specific spots, etc.), image data can be represented in different formats, such as, e.g., as a gray level profile, a two-dimensional image, or discrete pixels, etc. It is to be noted that in some cases the image data referred to herein can include, in addition to images (e.g., captured images, processed images, etc.), numeric data associated with the images (e.g., metadata, hand-crafted attributes, etc.). It is further noted that images or image data can include data related to a processing step/layer of interest, or a plurality of processing steps/layers of a specimen.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

The process of semiconductor fabrication often requires multiple sequential processing steps/layers, each one of which could possibly cause errors that may lead to yield loss. Examples of various processing steps can include lithography, etching, depositing, planarization, growth (such as, e.g., epitaxial growth), and implantation, etc. Various defect examination operations, such as defect detection, defect review, and defect classification, etc., can be performed at different processing steps/layers during the fabrication process to monitor and control the process. The examination operations can be performed a multiplicity of times, for example after certain processing steps/layers, or the like.

As described above, in some cases, machine learning (ML) technologies can be used to assist the defect examination process so as to provide accurate and efficient solutions. For purpose of providing a well-trained, accurate ML model that is robust with respect to various variations in actual production, training images must be sufficient in terms of quantity, quality, and variance, etc., and the images need to be annotated with accurate labels for supervised learning.

However, in some cases, such training data can be difficult to collect. By way of example, true defects (i.e., DOIs) are often scarce in number and subtle in appearance, thus tend to be buried within nuisances and noises, and are very difficult to detect. Therefore, training defect samples for certain types of DOIs may be very limited in number and does not include sufficient variances of the DOIs, taking into consideration different variations (such as, e.g., process variations and color variations) caused by some physical processes of the specimen. An ML model trained with insufficient defect training samples may not be able to detect unrepresented defects in production, thus cannot meet the required detection sensitivity (e.g., the detection result may have a high false alarm rate and low capture rate of the DOIs).

In addition, it may be particularly challenging to obtain label data for the training images containing defects, as human identification and annotation of such true defects, which are rare and hard to detect, typically takes time and effort, and, in some cases, may be error prone. Inaccurate labelling can mislead the ML model, and cause the model to be unable to identify the actual DOIs, or misclassify the defects in runtime, thus affecting detection performance.

Defect implanting techniques, such as implanting defect image patches in nominal images, are used in some cases to generate synthetic defects so as to enrich the training defect samples. However, such synthetically generated defects may tend to appear artificial and non-authentic with respect to the actual/real defects. Additionally, the synthetically generated defects may also not be sufficiently representative of different variations of the actual defects, thus causing a ML model trained with such synthetic defect training samples to not be capable of detecting actual defects with required detection performance.

Accordingly, certain embodiments of the presently disclosed subject matter propose a system and method for defect examination of semiconductor specimens, which do not have one or more of the disadvantages described above. The present disclosure proposes a two-pass learning process, including obtaining a plurality of actually acquired images of a semiconductor specimen, and processing the plurality of images using a first machine learning (ML) model to obtain, from the plurality of images, a set of images labeled with detected defects, and training a second ML model using a second training set comprising at least part of the set of images labeled with detected defects. The first ML model used in the processing is previously trained using a first training set comprising a subset of synthetic defective images each containing one or more synthetic defects, and a subset of nominal images. The training of the first ML model is referred to as a first pass of learning process. The training of the second ML model is referred to as the second pass of learning process. The second ML model, upon being trained, is usable for defect detection with improved detection performance with respect to the first ML model, as will be detailed below.

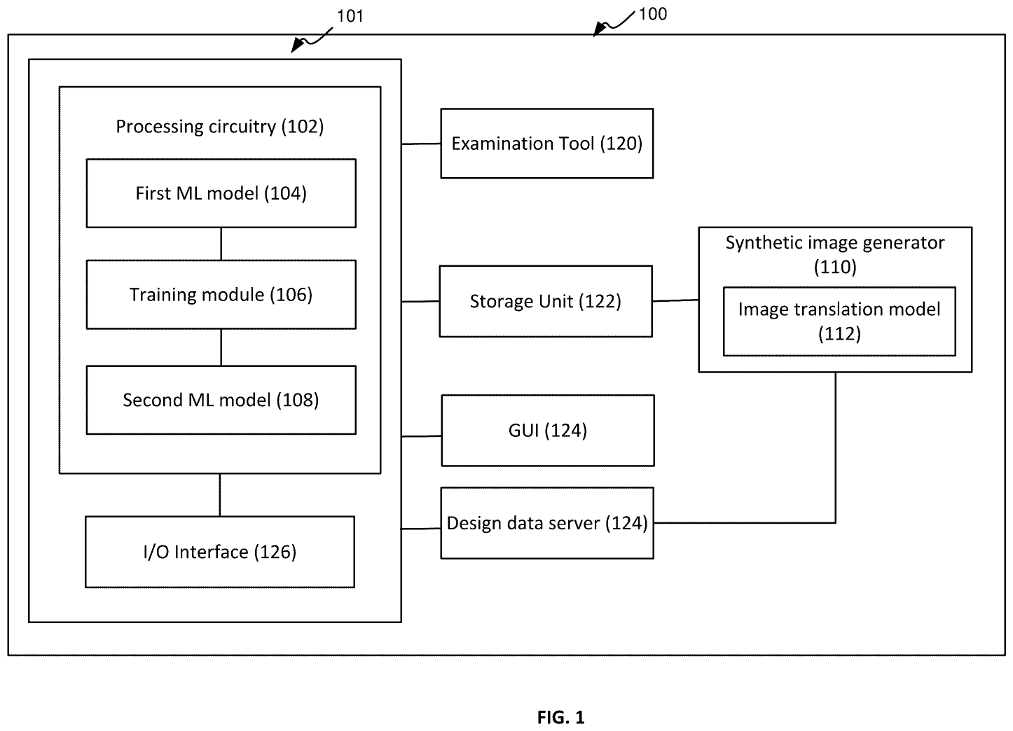

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of a semiconductor specimen (e.g., a wafer, a die, or parts thereof) as part of the specimen fabrication process. As described above, the examination referred to herein can be construed to cover any kind of operations related to defect inspection/detection, defect classification of various types, segmentation, and/or metrology operations with respect to the specimen. System 100 comprises one or more examination tools 120 configured to scan a specimen and capture images thereof to be further processed for various examination applications.

The term “examination tool(s)” used herein should be expansively construed to cover any tools that can be used in examination-related processes, including, by way of non-limiting example, scanning, imaging, sampling, reviewing, measuring, classifying, and/or other processes provided with regard to the specimen or parts thereof. The examination tools 120 can be implemented as machines of various types. In some embodiments, the examination tool can be implemented as an electron beam machine/tool, such as e.g., Scanning Electron Microscope (SEM), Atomic Force Microscopy (AFM), or Transmission Electron Microscope (TEM), etc.

By way of example, scanning electron microscopes (SEM) is a type of electron microscope that produces images of a specimen by scanning the specimen with a focused beam of electrons. An SEM is capable of accurately inspecting and measuring features during the manufacture of semiconductor wafers. The electrons interact with atoms in the specimen, producing various signals that contain information on the surface topography and/or composition of the specimen.

According to certain embodiments, the examination tool 120 can include one or more inspection tools and/or one or more review tools. The inspection tools can scan the specimen to capture inspection images and detect potential defects in accordance with a defect detection algorithm. The output of the detection module is a defect map indicative of defect candidate distribution on the semiconductor specimen. The review tools can be configured to capture review images at locations of the defect candidates in the map, and review the review images for ascertaining whether a defect candidate is indeed a DOI. In some cases, at least one of the examination tools 120 has metrology capabilities. Such an examination tool is also referred to as a metrology tool. The metrology tool can be configured to generate image data in response to scanning the specimen, and perform metrology operations based on the image data.

In some cases, the same examination tool can provide low-resolution image data and high-resolution image data. The resulting image data can be transmitted—directly or via one or more intermediate systems—to system 101. The present disclosure is not limited to any specific type of examination tools and/or the representation/resolution of image data resulting from the examination tools.

According to certain embodiments of the presently disclosed subject matter, the examination system 100 comprises a computer-based system 101 operatively connected to the examination tools 120. In some embodiments, system 101 can be configured as a training system capable of training a machine learning (ML) model during a training/setup phase. The ML model, upon being trained, can be used for performing defect examination for semiconductor specimens in runtime. In such cases, system 101 can also be referred to as a training system for the ML model.

In some embodiments, system 101 can be configured as a runtime defect examination system using the aforementioned trained ML model based on runtime images of semiconductor specimens acquired during a fabrication process thereof. Such a system 101 is also referred to as a defect examination system.

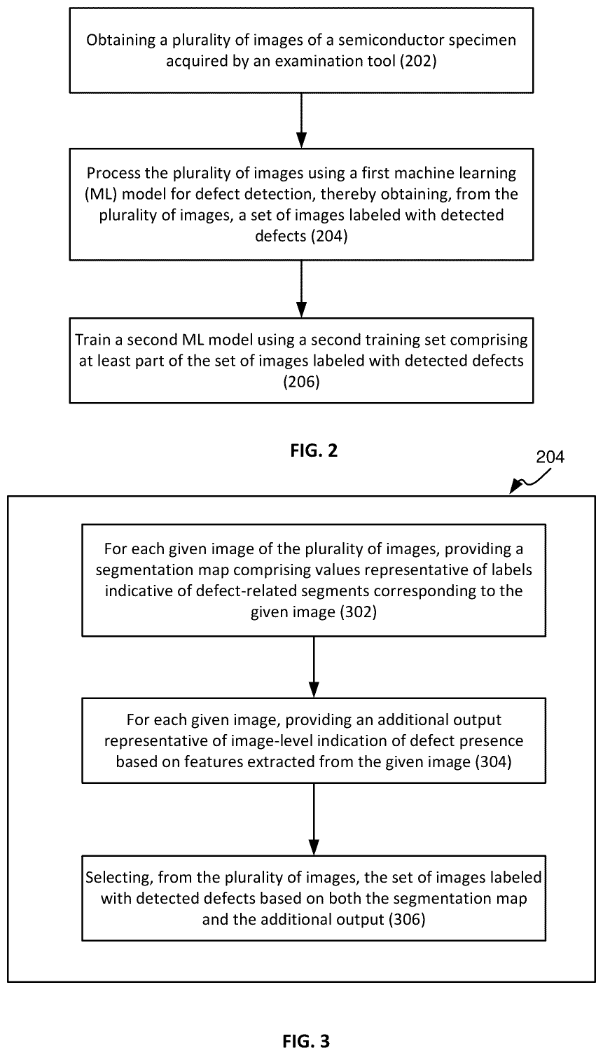

System 101 includes a processing circuitry 102 operatively connected to a hardware-based I/O interface 126 and configured to provide processing necessary for operating the system, as further detailed with reference to FIGS. 2-5. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

The one or more processors referred to herein can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

As described above, in some embodiments, system 101 can be configured as a training system capable of training a ML model during a training/setup phase, where the ML model, upon being trained, can be usable for runtime defect examination. In such cases, one or more functional modules comprised in processing circuitry 102 can include a first ML model 104, a training module 106, and a second ML model 108. Upon obtaining a plurality of images of a semiconductor specimen acquired by an examination tool (e.g., the examination tool 120), the first ML model 104 can be configured to process the plurality of images for defect detection, thereby obtaining, from the plurality of images, a set of images labeled with detected defects. It is to be noted that the first ML model used for defect detection refers to a trained ML model which was previously trained (e.g., by the training module 106) using a first training set comprising a subset of synthetic defective images each containing one or more synthetic defects, and a subset of nominal images.

The examination system 100 can further comprise a synthetic image generator 110 configured to generate the subset of synthetic defective images used for training the first ML model. In some embodiments, the synthetic image generator 110 can comprise an image translation model 112 usable for generating synthetic defective images based on design data stored in a design data server 124.

The training module 106 can be configured to train a second ML model 108 using a second training set comprising at least part of the set of images labeled with detected defects. The second ML model 108, upon being trained, is usable for defect detection with improved detection performance with respect to the first ML model.

In some embodiments, system 101 can be configured to perform runtime defect examination based on runtime images of a specimen acquired during a fabrication process thereof in the fab. In such cases, one or more functional modules comprised in PMC 102 can include the trained second ML model 108.

Operation of system 101, processing circuitry 102, and the functional modules therein, will be further detailed with reference to FIGS. 2-5.

According to certain embodiments, the first ML model 106 and the second ML model 112 referred to herein can be implemented as various types of machine learning models. The learning algorithms used by the ML models can be any of the following: supervised learning, unsupervised learning, or semi-supervised learning, etc. The presently disclosed subject matter is not limited to the specific type of ML model or the specific type of learning algorithm used by the ML model.

In some embodiments, the first ML model 106 and/or the second ML model 112 can be implemented as a deep neural network (DNN). DNN can refer to a supervised or unsupervised DNN model which includes layers organized in accordance with respective DNN architecture. By way of non-limiting example, the layers of DNN can be organized in accordance with Convolutional Neural Network (CNN) architecture, Recurrent Neural Network architecture, Recursive Neural Networks architecture, Generative Adversarial Network (GAN) architecture, or otherwise. Optionally, at least some of the layers can be organized into a plurality of DNN sub-networks. Each layer of DNN can include multiple basic computational elements (CE) typically referred to in the art as dimensions, neurons, or nodes.

The weighting and/or threshold values associated with the CEs of a deep neural network and the connections thereof can be initially selected prior to training, and can be further iteratively adjusted or modified during training to achieve an optimal set of weighting and/or threshold values in a trained DNN. After each iteration, a difference can be determined between the actual output produced by the DNN module, and the target output associated with the respective training set of data. The difference can be referred to as an error value. Training can be determined to be complete when a loss/cost function indicative of the error value is less than a predetermined value, or when a limited change in performance between iterations is achieved. A set of input data used to adjust the weights/thresholds of a deep neural network is referred to as a training set.

It should be noted that the teachings of the presently disclosed subject matter are not bound by specific architecture of the ML model or DNN as described above.

It is to be noted that while certain embodiments of the present disclosure refer to the processing circuitry 102 being configured to perform the above recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules, such as obtaining the plurality of images, processing the plurality of images using the first ML model, and training a second ML model, etc., can thus be performed by respective processors (or processor combinations) in the processing circuitry 102, while, optionally, at least some of these operations may be performed by the same processor. The present disclosure should not be limited to being construed as one single processor always performing all the operations.

In some cases, additionally to system 101, the examination system 100 can comprise one or more examination modules, such as, e.g., defect detection module and/or Automatic Defect Review Module (ADR) and/or Automatic Defect Classification Module (ADC) and/or a metrology-related module and/or other examination modules which are usable for examination of a semiconductor specimen. The one or more examination modules can be implemented as stand-alone computers, or their functionalities (or at least part thereof) can be integrated with the examination tool 120. In some cases, the output of system 101, e.g., the trained second ML model, the detected defects, etc., can be provided to the one or more examination modules for further processing. In some cases, the trained second ML model 108 can be comprised in the one or more examination modules. Optionally, the trained second ML model can be shared between the examination modules or, alternatively, each of the one or more examination modules can comprise its own second ML model.

According to certain embodiments, system 101 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store runtime images/training images produced by the examination tool 120 and/or derivatives thereof, as well as synthetic defective images generated by the synthetic image generator 110. Accordingly, the images can be retrieved from the storage unit 122 and provided to the processing circuitry 102 for further processing.

In some embodiments, system 101 can optionally comprise a computer-based Graphical User Interface (GUI) 124 which is configured to enable user-specified inputs related to system 101. For instance, the user can be presented with a visual representation of the specimen (for example, by a display forming part of GUI 124), including image data of the specimen. The user may be provided, through the GUI, with options of defining certain operation parameters, such as, e.g., configuration of the ML models, etc. The user may also view the operation results, such as, e.g., the detected defects, on the GUI.

In some cases, system 101 can be further configured to send, via I/O interface 126, the operation results to the examination tool 120 for further processing. In some cases, system 101 can be further configured to send the results to the storage unit 122, and/or external systems (e.g., Yield Management System (YMS) of a fabrication plant (fab)). A yield management system (YMS) in the context of semiconductor manufacturing is a data management, analysis, and tool system that collects data from the fab, especially during manufacturing ramp ups, and helps engineers find ways to improve yield. A YMS helps semiconductor manufacturers and fabs manage high volumes of production analysis with fewer engineers. These systems analyze the yield data and generate reports. A YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules and functions than those shown in FIG. 1.

Each component in FIG. 1 may represent a plurality of the particular component, which are adapted to independently and/or cooperatively operate to process various data and electrical inputs, and for enabling operations related to a computerized examination system. In some cases, multiple instances of a component may be utilized for reasons of performance, redundancy and/or availability. Similarly, in some cases, multiple instances of a component may be utilized for reasons of functionality or application. For example, different portions of the particular functionality may be placed in different instances of the component.

It should be noted that the examination system illustrated in FIG. 1 can be implemented in a distributed computing environment, in which one or more of the aforementioned functional modules shown in FIG. 1 can be distributed over several local and/or remote devices. By way of example, the examination tool 120 and the system 101 can be located at the same entity (in some cases hosted by the same device), or distributed over different entities, depending on specific system configurations and implementation needs. By way of another example, system 101 (or the first ML model 104 and/or the second ML model 108 thereof) and the synthetic image generator 110 (or the image translation model 112 thereof) can be located at the same entity, or distributed over different entities. In some examples, certain components utilize a cloud implementation, e.g., implemented in a private or public cloud. Communication between the various components of the examination system, in cases where they are not located entirely in one location or in one physical entity, can be realized by any signaling system or communication components, modules, protocols, software languages and drive signals, and can be wired and/or wireless, as appropriate.

It should be further noted that in other embodiments at least some of examination tools 120, storage unit 122 and/or GUI 124 can be external to the examination system 100 and operate in data communication with system 101 via I/O interface 126. System 101 can be implemented as stand-alone computer(s) to be used in conjunction with the examination tools, and/or with the additional examination modules, as described above. Alternatively, the respective functions of the system 101 can, at least partly, be integrated with one or more examination tools 120, thereby facilitating and enhancing the functionalities of the examination tools 120 in examination-related processes.

While not necessarily so, the process of operation of systems 101 and 100 can correspond to some or all of the stages of the methods described with respect to FIGS. 2-5. Likewise, the methods described with respect to FIGS. 2-5 and their possible implementations can be implemented by systems 101 and 100. It should therefore be noted that embodiments discussed in relation to the methods described with respect to FIGS. 2-5 can also be implemented, mutatis mutandis, as various embodiments of the systems 101 and 100, and vice versa.

Referring to FIG. 2, there is illustrated a generalized flowchart of defect examination in accordance with certain embodiments of the presently disclosed subject matter.

A plurality of images of a semiconductor specimen acquired by an examination tool can be obtained (202) (e.g., by the PMC 102 from the examination tool 120). A semiconductor specimen here can refer to a semiconductor wafer, a die, or parts thereof, that is fabricated and examined in the fab during a fabrication process thereof. An image of a specimen can refer to an image capturing at least part of the specimen. By way of example, an image can capture a given region or a given structure (e.g., a structural feature or pattern on a semiconductor specimen) that is of interest to be examined on a semiconductor specimen. For instance, the image can be an electron beam (e-beam) image acquired by an electron beam tool in runtime during in-line examination of the semiconductor specimen. It is to be noted that the plurality of images refers to real images of the specimen that are actually acquired by the tool, contrary to synthetic images, as will be described below.

The fabrication process of a specimen typically comprises multiple processing steps. In some cases, a sampled set of processing steps can be selected therefrom for in-line examination, based on their known impacts on device characteristics or yield. Images of the specimen or parts thereof can be acquired at the sampled set of processing steps to be examined. For purpose of illustration only, certain embodiments of the following description are described with respect to images acquired for a specific processing step/layer of the sampled set of processing steps. Those skilled in the art will readily appreciate that the teachings of the presently disclosed subject matter are also applicable to multiple processing steps of a specimen.

The plurality of images can be processed (204) using a first ML model (e.g., the ML model 104) for defect detection, thereby obtaining, from the plurality of images, a set of images labeled with detected defects. The detected defects referred to herein can refer to any type of defective features on a specimen such as, e.g., a bridge, particles, line-cuts, protrusion, intrusion, missing pattern, etc. In some cases, the defects can also include variations related to any pattern, structure, or image, such as, e.g., bent lines, edge roughness, surface roughness, CD variation/shift, gray level variation, etc. It is to be noted that the variations referred to herein should not be limited to any specific size or resolution. There may be considered a presence of “variation” if one or more measurements and/or detections indicate that one or more characteristics of a design formed on the specimen are outside of a desired range of values for those one or more characteristics.

According to certain embodiments, the processing of the images can comprise, for each given image of the plurality of images, providing, by the first ML model, a segmentation map comprising values representative of labels indicative of defect-related segments corresponding to the given image, and selecting, from the plurality of images, a set of images each associated with a segmentation map comprising one or more labels representative of defect presence. The selected set of images constitutes the set of images labeled with detected defects. An image labeled with at least one detected defect is also referred to as a defective image. A defective image used herein refers to an image that comprises, or has a high probability of comprising, defective features on a specimen.

In some cases, the segmentation map of a given image can be generated at pixel level, where each label corresponds to a pixel in the given image and represents the segment that the corresponding pixel belongs to. In some other cases, the segmentation map can be generated at a structure level or a region level, where each label corresponds to a structure or a region in the given image and representing the segment that the corresponding structure or region belongs to. The segments used for labeling can include a defective segment and a non-defective segment. In some cases, the defective segment can further indicate the type of defect presented in the segment.

According to certain embodiments, for the purpose of generating the segmentation map, a score map corresponding to a given image is first generated by the first ML model. For instance, the score map can comprise scores indicative of pixel-level probabilities of presence of defects in the given image. A predefined defect threshold can be applied to the scores in the score map. For instance, for a pixel whose score is higher than the threshold, a value of 1 will be applied, otherwise a value of 0 will be applied. In such ways, the score map can be transformed into a binary segmentation map, where the values of 1 represent a defective segment that the corresponding pixels in the given image belong to (i.e., these pixels are defective pixels), while the values of 0 represent a non-defective segment that the corresponding pixels in the given image belong to (i.e., these pixels are non-defective pixels). In some cases, the score map can be consolidated at a structure or region level, prior to applying the defect threshold, thereby giving rise to a segmentation map at a structure or region level.

It is to be noted that although the segmentation map is exemplified above as a binary segmentation map deriving from the score map, the term segmentation map referred to herein should be broadly construed to cover the score map and/or the binary segmentation map.

According to certain embodiments, the first ML model can be implemented using various DNN architectures, such as, e.g., CNN, GAN, etc. Should one take CNN as an exemplary implementation of the first ML model, CNN normally has a structure comprising an input and an output layer, as well as multiple hidden layers. The hidden layers of a CNN typically comprise a series of convolutional layers, subsequently followed by additional layers, such as pooling layers, fully connected layers, and normalization layers, etc. In some cases, a CNN can be regarded as being composed of two main functionalities/parts: an encoder, and a decoder. The encoder performs feature extraction by encoding the input image into features of various semantic levels. The decoder decodes these features into a segmentation map. The encoder and decoder usually include convolutional layers, fully connected layers, activation functions, normalization layers, and/or pooling layers.

In some cases, a convolutional layer in the feature extraction part comprises a set of learnable filters and parameters. Each filter of a specific layer can be convolved across the width and height of an input volume of a given input image, computing the dot product between the entries of the filter and the input, and then applying an activation function, and producing an activation map which gives the responses of that filter at every spatial position. Stacking the activation maps for all filters along the depth dimension forms the full output feature maps of a given convolution layer. In such ways, the CNN learns of filters that activate when it detects some specific type of features at some spatial position in the input. The output feature map is a representation of extracted features in the input image.

As CNN comprises a series of convolutional layers, the output feature maps can be extracted from any one of the convolutional layers of the CNN. Typically, early layers of deep neural networks learn lower-level features, while deeper layers learn more high-level features. According to certain embodiments of the present disclosure, an additional output can be provided by the CNN based on the feature maps extracted from at least one of the convolutional layers (in addition to the output of the segmentation map). The additional output can be representative of image-level indication of defect presence, produced by inputting the output of one or more convolutional layers into a classification head. By way of example, the classification head can be composed of a few convolutional layers, followed by global average pulling, fully connected layers, and a sigmoid activation function.

In such cases, the set of images labeled with detected defects can be selected based on the consistency between the segmentation map and the additional output. By way of example, in cases where both outputs indicate presence of defects, the given image will be selected to be included in the set of images. In such ways, the selected images have a high certainty to be actual defective images (and not false alarms).

FIG. 3 illustrates a generalized flowchart of selecting a set of images with detected defects in accordance with certain embodiments of the presently disclosed subject matter. For each given image of the plurality of images, a segmentation map can be provided (302), comprising values representative of labels indicative of defect-related segments corresponding to the given image. In addition, for each given image, an additional output can be provided (304), representative of image-level indication of defect presence based on features extracted from the given image. In such cases, the set of images labeled with detected defects can be selected (306) based on both the segmentation map and the additional output. By way of example, such selection can be based on consistency between the two outputs.

FIG. 6 illustrates a schematic illustration of an exemplary first ML model providing multiple outputs in accordance with certain embodiments of the presently disclosed subject matter.

The first ML model is exemplified as a U-net in FIG. 6. U-net is a type of CNN. It comprises a contracting path (denoted as the encoder part in the figure) and an expansive path (denoted as the decoder part in the figure) which is more or less symmetric to the contracting path, thus yielding a U-shaped architecture. A given image (e.g., one of the plurality of captured images) can be provided to the input layer 602 of the network, and, after processing, a score map 604 can be outputted, comprising scores indicative of pixel-level probabilities of presence of defects in the given image. As described above, the score map 604 can be processed to provide a segmentation map where the values of 1 represent a defective segment that the corresponding pixels in the given image belong to, while the values of 0 represent a non-defective segment that the corresponding pixels in the given image belong to.

In some cases, besides the output of the score map or segmentation map, an additional output 606 can be provided based on the feature map extracted from at least one of the convolutional layers in the encoder part or following the encoder part. As exemplified, the feature map extracted from a convolutional layer 608 can be processed via a classification head 610, thereby obtaining the additional output 606 representative of image-level indication of defect presence. For a given input image, if both the output of the segmentation map and the additional output indicate defect presence, the given image labeled with the defect indicated by the segmentation map can be selected to be included in the set of images, as described above with reference to block 204.

In some further embodiments, in addition to or in lieu of the additional output 606, an output of an uncertainty map for the score map 604 and/or the segmentation map can be generated. The uncertainty map comprises values representative of the level of uncertainty of the defect-related segments as indicated by the segmentation map or the score map, and can be generated, e.g., as an additional output from the decoder of the ML model, in parallel to the score map. In such cases, the set of images labeled with detected defects can be selected based on both the segmentation map and the uncertainty map. By way of example, a given image having pixels of which the segmentation map indicates defect presence with a high certainty indicated by the uncertainty map will be selected, where these pixels are labeled as detected defects.

In some cases, multiple score maps can be generated, and an overall score map can be derived based on the multiple score maps (e.g., as the average of the score maps). By way of example, defect detection using the first ML model (at inference stage) can be performed multiple times, e.g., by applying dropout of certain outputs of some layers randomly at inference, and multiple score maps can be obtained. Alternatively, a few ML models (e.g., segmentation models) can be trained with different subsets of the training set, which, in runtime, can be used to generate respective score maps. Another possible way of obtaining several score maps is by having a multi-input-multi-output (MIMO) segmentation network, where each input image is mapped to a score map, where some of the hidden layers are shared in producing the different score maps. During training, different images are inputted into the network, giving rise to different score maps, while at inference, the same image is used in all inputs, yielding multiple score maps. The overall score map can be used to derive the segmentation map. In cases where an uncertainty map is used, the uncertainty map can be generated as the standard deviation or entropy for each pixel of these multiple score maps. The selection of the set of images can be based on the segmentation map obtained from the overall score map and the uncertainty map, in a similar manner as described above.

The first ML model used in the processing in block 204 is a trained ML model. FIG. 5 illustrates a training process for the first ML model according to certain embodiments of the presently disclosed subject matter. A first training set of images can be obtained (502), comprising a subset of synthetic defective images, each containing one or more synthetic defects, and a subset of nominal images. In some cases, optionally, the first training set can further comprise a subset of real defective images (i.e., actually captured defective images, not synthetically generated defective images). The first ML model can be pre-trained (504) during a training/setup phase using the first training set of images.

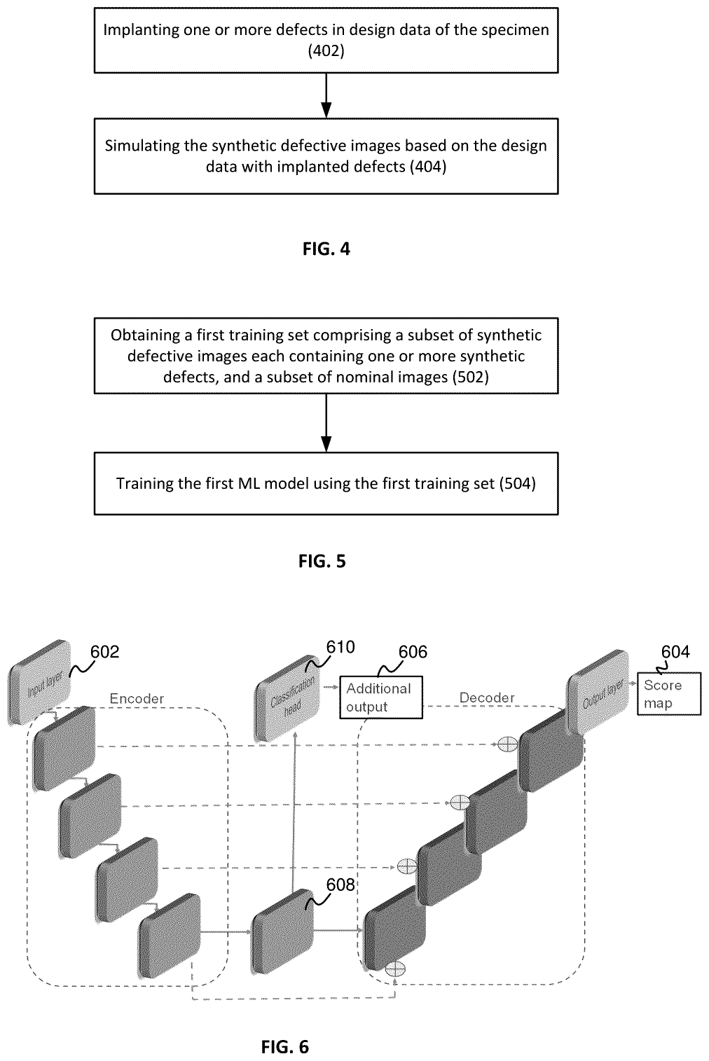

FIG. 4 illustrates a generalized flowchart of generating the subset of synthetic defective images according to certain embodiments of the presently disclosed subject matter. One or more defects can be implanted (402) in design data of the specimen, and the synthetic defective images can be simulated (404) based on the design data with implanted defects. The design data can refer to the original design layout data of the specimen, such as CAD data. In some cases, the design data of the specimen can be provided by the customer. In cases where the design data is not available, it can be generated based on an actual image of the specimen, such as, e.g., a SEM image captured by a SEM tool. By way of example, the SEM image can be analyzed, and feature extraction can be performed on the image. For instance, the extracted features can be representative of the structure and/or pattern and/or style of any structural features in the image, such as, e.g., edges, corners, pixel intensities, measurements related thereto, etc. Design data, such as a design image (e.g., CAD image) corresponding to the SEM image, can be simulated based on the extracted features. Alternatively, defects can be implanted directly onto the actual SEM image of the specimen by, e.g., manipulating extracted features from the SEM image and decoding them to a defective image using an image translation network.

One or more candidate regions can be found in the design data based on the type of defect to be implanted. By way of example, in cases where the defect to be implanted is a bridge, the candidate regions including a pattern of two gapped structures, such as, e.g., two parallel line structures, can be identified. In some cases, feature based matching techniques which are based on comparison of characteristics of features/structures can be used for identifying the candidate regions, in particular with respect to patterns of the same type/nature that may vary in terms of geometric transformations such as scaling, shifts, rotations, etc., gray level intensities, and/or contrast changes, etc. For instance, candidate regions containing parallel line structures with different widths of lines and/or different distances between the lines can be identified using such techniques.

The defect to be implanted can be integrated in the candidate regions of the design data as identified. According to certain embodiments, one or more image characteristics of the defect feature or part thereof can be manipulated before being implanted in the design. By way of example, the manipulation can be based on at least one of the following: geometric transformation (including translation, rotation, scaling, shear mapping, etc.), gray level intensity modifications, style transfer, etc. The defect feature can be adjusted in one or more of these aspects in accordance with the characteristics of the candidate regions, and the adjusted feature can be implanted to the candidate regions.

Once the defects are implanted in the design data, image simulation can be performed based on the design data with implanted defects to generate synthetic defective images.

According to certain embodiments, the image simulation can be performed to simulate one or more physical effects caused by one or more physical processes of the semiconductor specimen, thereby giving rise to the set of synthetic defective images. According to certain embodiments, the effects can refer to variations caused by one or more of the following physical processes: a manufacturing/fabrication process (FP) for fabricating a specimen (e.g., printing the design patterns of the specimen on the wafer by a lithography tool), a scanning process for scanning the fabricated specimen, and a signal processing process for processing scanned signals to generate the synthetic defective images (e.g., in the examination process by the examination tool), etc.

By way of example, physical effects caused by the fabrication process (FP) of the specimen can be simulated to represent how the design patterns in the design data would actually appear on the wafer. In other words, the FP simulation transfers the design intent layout to the expected processed pattern on the wafer. By way of another example, in cases of examination by an electron beam tool such as SEM, the physical effects of the scanning process can be simulated by representing the e-beam signal based on yield of electrons emitted from the specimen and detected by a detector. By way of yet another example, the signal processing simulation reflects the influence of the signal processing path in the examination tool on the e-beam signal. In some cases, process variation (PV) and gray level (GL) variations can be considered during such simulations. A simulated image is obtained after performing one or more of the above simulations, such as a simulated SEM image.

According to certain embodiments, the image simulation can be performed based on machine learning. By way of example, an image translation model trained for translating design data to synthetic images can be used. The image translation model can be implemented using various ML model architectures, such as, e.g., CNN, autoencoder, GAN, etc. By way of example, the image translation model can be pre-trained using a set of training samples, each comprising a design image and a corresponding actual image such as SEM image. The model can be trained to learn to map between the two image representations. Upon being trained, given the input of the design data with implanted defects, the model can output a synthetic defective image corresponding thereto.

The synthetic defective images generated as described above effectively enriches the training set used for training the first ML model, and addresses the issues of lack of defective training images, as well as the annotation efforts thereof. The first ML model trained using such training set, when being used in runtime examination to process actually captured images, is proven to have high detection performance, in particular with respect to detection precision (i.e., the percentage of the detected defects being true defects, and not false alarms). By way of example, a first ML model trained using a subset of a few hundreds of synthetic defective images, each containing one or more synthetic bridge defects and a subset of a few hundreds of nominal images, can achieve a precision rate of 90% or above, indicating that the defects detected by the first ML model have a very high probability of being true defects and not false alarms.

Therefore, the detected defects which are detected from real images (thus preserving natural image characteristics and various variations of defects as appearing in actual production, as compared to synthetic defective images) and are proven to have high probability of being true defects, can be used directly as high quality of defective training samples without further review/verification by human reviewers. In some cases, additional filtering mechanisms, such as the additional output by the classification head, and/or the uncertainty map as described above, can be applied to filter/select the set of images to be used as training samples. The training using such defective training samples is also referred to as “privileged learning”. In some cases, the training of the second ML model using such defective training samples can be also referred to as a second pass of the learning process, with respect to a first pass which refers to the training of the first ML model using synthetic defective images.

In some embodiments, the second pass of training can be repeated multiple times, each pass using defective training samples which are real defect images detected by one or more ML models resulting from one or more previous passes. In such cases, the ML model resulting from the final pass can be referred to as a final ML model, which can be used in runtime defect detection. The present disclosure is not limited by the number of learning passes to be applied for obtaining the final ML model. For instance, the second ML model can be regarded as the final ML model, when the number of learning passes is two.

Referring back to FIG. 2, once the set of images labeled with detected defects are obtained, a second ML model (e.g., the second ML model 108) can be trained (206) (e.g., by the training module 106) using a second training set comprising at least part of the set of images labeled with detected defects. With respect to nominal training images, in some cases the second training set can comprise the subset of nominal images (that was part of the first training set) or part thereof. In some other cases, nominal training images can be created based on the set of images labeled with detected defects. For instance, as the detected defects are labeled in the set of images, the images can be cropped according to the labels, and the image portions that do not contain any defective features can be used as nominal training images.

The second ML model, upon being trained, is usable for runtime defect detection, and is proven to have improved detection performance as compared to the first ML model. The improved detection performance can be represented by at least one of the following detection measures: precision, recall (also referred to as capture rate, the percentage of detected defects with respect to the total amount of defects), filter rate, and false alarm rate (the percentage of false alarms in the detected defects). By way of example, it is proven that the detection precision of the second ML model is further improved as compared to the first ML model. For instance, a second ML model trained using the detected defects by the first ML model and the same subset of nominal images, can reach a precision rate of 95%-99%, as compared to the precision rate of around 90% of the first ML model.

By way of another example, the detection recall of the second ML model is significantly improved as compared to the first ML model. The recall rate (i.e., capture rate) of the first ML model in the above example is approximately in the range of 70-80%, indicating that although the first ML model can capture a large percentage of the total amount of defects, it still misses about 20-30% defects. This may possibly result from the fact that the synthetic defects used to train the first ML model are not sufficiently representative of different types of variations of the actual defects. On the other hand, the second ML model trained using the detected defects by the first ML model, which result from real images and have high probability of being true defects, can manage to achieve a recall rate of 90% or above, indicating that the second ML model is capable of capturing most of the defects that are present.

In some embodiments, the second ML model can be based on the first ML model. By way of example, the second ML model can be implemented using the trained first ML model or part thereof, thus benefiting from the previous training outcome. For instance, the trained first ML model can be used as the initial version of the second ML model, which will be trained as described with reference to block 206. In such cases, the training of the second ML model is in fact a re-training process for the first ML model. The trained second ML model can be also referred to as a retrained first ML model with updated trained parameters. In some cases, the second ML model can be initialized based on only part of the trained parameters of the trained first ML model. In such cases, it can be further configured which part of the model parameters of the first ML model is to be used for initializing the second ML model.

In some further embodiments, the second ML model can be a different model from the first ML model. For instance, a new ML model can be employed and the training with reference to block 206 can be performed with respect to the new ML model.

The training process of the second ML model can be performed in a similar manner as of the first ML model, as described above, the details of which will not be repeated here for purpose of brevity of the description.

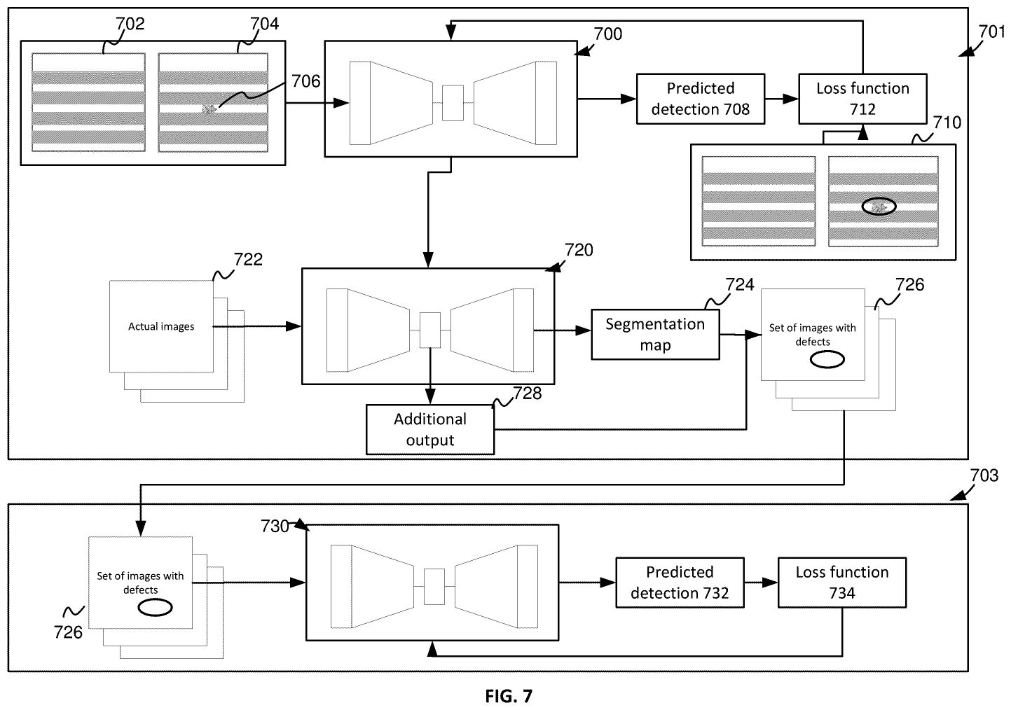

Referring now to FIG. 7, there is illustrated a schematic illustration of the employment of the first ML model and the second ML model in the defect examination system in accordance with certain embodiments of the presently disclosed subject matter.

The diagram 701 illustrates the training phase and inference phase of a first ML model 700 as exemplified in FIG. 7. For training the first ML model 700, a first training set of images is obtained, comprising a subset of synthetic defective images 704 each containing one or more synthetic defects 706, and a subset of nominal images 702 free of defective features. As described with reference to FIG. 4, the synthetic defective images 704 can be generated by implanting one or more defects into the design data of the specimen, or into the image of the specimen itself, and performing image simulation based on the design data with implanted defects.

For each given training image, the first ML model 700 can process it and provide a predicted detection output 708 indicative of whether there is any detected defect in the given image. By way of example, the predicted detection output 708 can be in the form of a segmentation map, as described above. A loss function 712 can be used to evaluate the predicted detection output 708 with respect to the corresponding ground truth 710 of the given training image indicative of the labeled defect thereof (denoted by an ellipse for a defective image, and no markings for a nominal image). The loss function 712 can represent a difference between the predicted detection output and the ground truth associated with the respective training image. The ML model can be optimized by minimizing the value of the loss function. Training can be determined to be complete when the value of the loss function is less than a predetermined value, or when a limited change in performance between iterations is achieved.

Upon being trained, the trained first ML model 720 can be deployed in inference for runtime defect examination. A plurality of images 722 of a specimen which are actually captured by an examination tool during runtime examination can be processed by the trained first ML model 720, and for each given image, a segmentation map 724 can be outputted, comprising labels indicative of a defective segment or a non-defective segment. As described above, the segmentation map can be generated at pixel level, where each label corresponds to a pixel in the given image and represents the segment that the corresponding pixel belongs to. The segmentation map can also be generated at a structure level or a region level, where each label corresponds to a structure or a region in the given image and representing the segment that the corresponding structure or region belongs to.

Using the segmentation maps, a set of images 726 each associated with a segmentation map comprising one or more labels representative of defect presence, can be selected from the plurality of images 722. As described above, in some cases, an additional output 728 can be extracted based on an output feature map extracted from a convolutional layer (e.g., via a classification head). The additional output 728 can be representative of image-level indication of defect presence. The set of images 726 can be selected based on both the segmentation map 724 and the additional output 728. For instance, for a given input image, if both the output of the segmentation map and the additional output indicate defect presence, the given image labeled with the defect indicated by the segmentation map can be selected to be included in the set of images. In some cases, in addition to or in lieu of the additional output 728, an uncertainty map can be derived based on the score map and/or segmentation map, and used for selecting the set of images, as described above.

The diagram 703 illustrates the training process of a second ML model 730. The set of images 726 labeled with defects, together with a set of nominal images (e.g., either as part of the nominal images 702, or derived from the set of images 726), can be used as a second training set to train the second ML model 730. Similarly, for each training image, the second ML model can output a predicted detection output 732, which will be evaluated using a loss function 734 with respect to the corresponding ground truth labels of the training image, and the second ML model can be optimized by minimizing the value of the loss function.

The second ML model 730, upon being trained, can be used in runtime defect examination. As described above, the second ML model has proved to have improved defect detection performance as compared to the first ML model 720.

It is to be noted that the first ML model and/or the second ML model can be implemented as various types of ML models, and the illustration of these models in FIG. 7 is for exemplary purposes only.

According to certain embodiments, the process as described above with reference to FIG. 2 can be included as part of a process for generating an examination recipe usable by the examination system 100 and/or the examination tool 120 for online examination in runtime. Upon being trained, the trained second ML model can be included as part of the examination recipe. It is to be noted that the term “examination recipe” should be expansively construed to cover any recipe that can be used by an examination tool for any examination application, such as, e.g., a defect detection or defect review application, including the embodiments as described above.

It should be noted that examples illustrated in the present disclosure, such as, e.g., the exemplary ML models and structures, the training data and processes, the examination tools, the image simulation methods, etc., are illustrated for exemplary purposes, and should not be regarded as limiting the present disclosure in any way. Other appropriate examples/implementations can be used in addition to, or in lieu of the above.

Among advantages of certain embodiments of the defect examination system and method as described herein is that using the two-pass learning process (or multi-pass learning process, as described above), as described above, can result in a trained ML model (i.e., the trained second ML model) that is capable of performing defect examination with significantly improved detection performance.

This is achieved at least partially by the fact that the second ML model is trained using high quality of defective training samples which are selected based on a first ML model's processing, and are proven to have high probability of being true defects. In addition, these defective training samples are selected from real images, thus preserving natural image characteristics and various variations of defects as appearing in actual production, as compared to synthetic defective images.

By way of example, a second ML model trained using the detected defects by the first ML model can reach a very high precision rate of 95%-99%. In addition, the recall rate of the second ML model can reach 90% or above, signifying an improvement from the recall of the first ML model, indicating that the second ML model is capable of capturing most of the defects that are present.

Among further advantages of certain embodiments of the process monitoring system and method as described herein is that the set of images labeled with detected defects that are used for training the second ML model can be selected based on an output of a segmentation map and an additional output representative of image-level indication of defect presence based on features extracted from a given image. The selection and verification, based on the consistency of the two outputs, further increases the probability of the selected images containing true defects, and not false alarms.

It is to be understood that the present disclosure is not limited in its application to the details set forth in the description contained herein or illustrated in the drawings.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system of semiconductor specimen examination, the system comprising a processing circuitry configured to:
obtain a plurality of images of a semiconductor specimen acquired by an examination tool;
process the plurality of images using a first machine learning (ML) model for defect detection, thereby obtaining, from the plurality of images, a set of images labeled with detected defects, wherein the first ML model is previously trained using a first training set comprising: a subset of synthetic defective images each containing one or more synthetic defects, and a subset of nominal images; and
train a second ML model using a second training set comprising at least part of the set of images labeled with detected defects, wherein the second ML model, upon being trained, is usable for defect detection with improved detection performance with respect to the first ML model.

2. The computerized system according to claim 1, wherein the second ML model is based on the first ML model.

3. The computerized system according to claim 1, wherein the second ML model is a new ML model different from the first ML model.

4. The computerized system according to claim 1, wherein the processing comprises, for each given image of the plurality of images, providing a segmentation map comprising values representative of labels indicative of defect-related segments corresponding to the given image, and selecting, from the plurality of images, a set of images each associated with a segmentation map comprising one or more labels representative of defect presence.

5. The computerized system according to claim 4, wherein the processing further comprises, for each given image, providing an additional output representative of image-level indication of defect presence based on features extracted from the given image, and wherein the selecting comprises selecting the set of images labeled with detected defects based on consistency between the segmentation map and the additional output.

6. The computerized system according to claim 4, wherein the processing further comprises, for each given image, providing an uncertainty map comprising values representative of respective uncertainty of the defect-related segments indicated by the segmentation map, and wherein the selecting comprises selecting the set of images labeled with detected defects based on the segmentation map and the uncertainty map.

7. The computerized system according to claim 1, wherein the subset of synthetic defective images is generated by implanting one or more defects in design data of the specimen, and simulating the synthetic defective images based on the design data with implanted defects.

8. The computerized system according to claim 7, wherein the simulation is performed by simulating physical effects of one or more processes including a fabrication process for fabricating a specimen based on the design data, a scanning process for scanning the fabricated specimen, and a signal processing process for processing scanned signals to generate the synthetic defective images.

9. The computerized system according to claim 7, wherein the simulation is performed using an image translation model trained for translating design data of a specimen to a synthetic image.

10. The computerized system according to claim 7, wherein the design data is generated based on an actual image of the specimen.

11. The computerized system according to claim 1, wherein the first training set further comprises a subset of real defective images.

12. The computerized system according to claim 1, wherein the improved detection performance is represented by at least one of following detection measures: precision, recall, filter rate, and false alarm rate.

13. A computerized method of semiconductor specimen examination, the method comprising:
obtaining a plurality of images of a semiconductor specimen acquired by an examination tool;
processing the plurality of images using a first machine learning (ML) model for defect detection, thereby obtaining, from the plurality of images, a set of images labeled with detected defects, wherein the first ML model is previously trained using a first training set comprising: a subset of synthetic defective images each containing one or more synthetic defects, and a subset of nominal images; and
training a second ML model using a second training set comprising at least part of the set of images labeled with detected defects, wherein the second ML model, upon being trained, is usable for defect detection with improved detection performance with respect to the first ML model.

14. The computerized method according to claim 13, wherein the second ML model is based on the first ML model.

15. The computerized method according to claim 13, wherein the processing comprises, for each given image of the plurality of images, providing a segmentation map comprising values representative of labels indicative of defect-related segments corresponding to the given image, and selecting, from the plurality of images, a set of images each associated with a segmentation map comprising one or more labels representative of defect presence.

16. The computerized method according to claim 15, wherein the processing further comprises, for each given image, providing an additional output representative of image-level indication of defect presence based on features extracted from the given image, and wherein the selecting comprises selecting the set of images labeled with detected defects based on consistency between the segmentation map and the additional output.

17. The computerized method according to claim 15, wherein the processing further comprises, for each given image, providing an uncertainty map comprising values representative of respective uncertainty of the defect-related segments indicated by the segmentation map, and wherein the selecting comprises selecting the set of images labeled with detected defects based on the segmentation map and the uncertainty map.

18. The computerized method according to claim 13, wherein the subset of synthetic defective images is generated by implanting one or more defects in design data of the specimen, and simulating the synthetic defective images based on the design data with implanted defects.

19. The computerized method according to claim 13, wherein the improved detection performance is represented by at least one of following detection measures: precision, recall, filter rate, and false alarm rate.

20. A non-transitory computer readable storage medium tangibly embodying a program of instructions that, when executed by a computer, cause the computer to perform a method of semiconductor specimen examination, the method comprising:
obtaining a plurality of images of a semiconductor specimen acquired by an examination tool;
processing the plurality of images using a first machine learning (ML) model for defect detection, thereby obtaining, from the plurality of images, a set of images labeled with detected defects, wherein the first ML model is previously trained using a first training set comprising: a subset of synthetic defective images each containing one or more synthetic defects, and a subset of nominal images; and
training a second ML model using a second training set comprising at least part of the set of images labeled with detected defects, wherein the second ML model, upon being trained, is usable for defect detection with improved detection performance with respect to the first ML model.
